(19) United States
(12) Patent Application Publication
(10) Pub. No.: US 2018/0045547 A1
(43) Pub. Date: Feb. 15, 2018

(54) SMART CUP, DRINKING AMOUNT DETECTING METHOD FOR SMART CUP AND SYSTEM THEREFOR

(71) Applicant: BOWHEAD TECHNOLOGY (SHANGHAI) CO., LTD., Shanghai (CN)

(72) Inventors: Gang ZHANG, Shanghai (CN); Rul XU, Shanghai (CN); Yizhen JIANG, Shanghai (CN); Chih-chiang CHIANG, Taipei (TW)

(21) Appl. No.: 15/557,825

(22) PCT Filed: Jan. 18, 2016
(86) PCT No.: PCT/CN2016/071166

§ 371 Date: Sep. 13, 2017

(30) Foreign Application Priority Data
Mar. 17, 2015 (CN) 201510116795

(51) Int. Cl. G01F 22/00; A47G 19/22

(52) U.S. Cl. CPC G01F 22/00; A47G 19/2205; G01F 9/006

(57) ABSTRACT

A smart cup, comprising a cup body (110), a cup cover (120), a light sensor (130) and a main board (140), wherein the cup cover (120) is arranged on the cup body (110), the light sensor (130) is arranged on the cup body (110) and is covered by the cup cover (120), the light sensor (130) can be exposed by opening the cup cover (120), the main board (140) is arranged at the bottom part of the cup body (110) and is isolated from an inner cavity of the cup body (110), the main board (140) is provided with a main processor (141) and a gravitational accelerometer (142), and the light sensor (130) and the gravitational accelerometer (142) are both connected to the main processor (141).

### BACKGROUND OF THE INVENTION

The present invention belongs to the field of smart cup, particularly relates to a smart cup, drinking amount detecting method for smart cup and system therefor.

The methods of measuring a drinking amount for conventional smart cups are classified in two types: in contact with fluid and not in contact with fluid.

For the contact-fluid type measurements, a corresponding sensor has to be placed in the fluid. For placing a sensor directly in the drinking water, sanitary security cannot be guaranteed.

For the non-contact type measurements, pressure sensors are basically used at present; by placing it at the bottom of a cup, the weight of water is measured. However, one must wait until the cup is in a static steady state before measuring can start. A drinking amount cannot be measured in real time.

### BRIEF SUMMARY OF THE INVENTION

For this reason, to solve the above-mentioned technical problems, a smart cup, drinking amount detecting method for smart cup and system therefor is provided.

In order to solve the above-mentioned technical problems, the present invention adopts the technical scheme as follows:

A smart cup comprises a cup body, a cup cover, a light sensor and a main board, wherein the cup cover is arranged on the cup body, the light sensor is arranged on the cup body and is covered by the cup cover, the light sensor can be exposed by opening the cup cover, the main board is arranged at a bottom part of the cup body and is isolated from an inner cavity of the cup body, the main board is provided with a main processor and a gravitational accelerometer, and the light sensor and the gravitational accelerometer are both connected to the main processor.

The cup body is screwed to the cup cover, and the light sensor is arranged on a receiving surface where the cup body is connected to a lower end surface of the cup cover.

The cup cover comprises a cup cover body, a shading tube and a slide cover, wherein the cup cover body has a peripheral wall with a vertical groove, and an upper end surface provided with a slide rail from the groove to a center of the cup cover body. The shading tube is arranged in the groove, and the shading tube is located just above the light sensor after the cup cover and the cup body are screwed together. The slide cover is arranged in the slide rail. The shading tube has an upper tube opening which can be opened or closed by sliding the slide cover back and forth in the slide rail.

The present scheme also relates to a drinking amount detecting method for smart cup, comprising:

Detecting light in real time by the light sensor, detection of presence of light indicates that the cup cover is opened or the slide cover on the cup cover is opened; after the cup cover or the slide cover is opened, detection of dimming of light indicates that user tries to drink water and the gravitational accelerometer is activated;

Calculating inclination of the smart cup relative to a vertical direction by the gravitational accelerometer, and sending data of the inclination to the main processor;

Calculating mean and variance of each set of the data of the inclination by the main processor, wherein each set of the data of the inclination comprises a pluraity of units of data of the inclination; if the mean is larger than a preset angle of drinking water and the variance is less than 1°, the corresponding mean is an initial angle of drinking water. The preset angle of drinking water is 9° to 15°; a maximum value of the means is determined, and the corresponding mean around the maximum value is taken as a maximum angle of drinking water;

Calculating an initial water amount according to the initial angle of drinking water and capacity of the smart cup by the main processor, and calculating a remaining water amount according to the maximum angle of drinking water and capacity of the smart cup by the main processor; then calculating a difference between the initial water amount and the remaining water amount to obtain a drinking amount.

The preset angle of drinking water is 10°.

In this method, each set of data of the inclination comprises 1024 units of data of the inclination.

The present scheme also relates to a drinking amount detecting system for smart cup, comprising:

a light detection unit for detecting light in real time by a light sensor; detection of presence of light indicates that a cup cover is opened or a slide cover on the cup cover is opened; after the cup cover or the slide cover is opened, detection of dimming of light indicates that user tries to drink water and the gravitational accelerometer is activated;

an inclination calculation unit which calculates inclination of the smart cup relative to a vertical direction by the gravitational accelerometer, and sending data of the inclination to a main processor;

an angle of drinking water analysis unit for calculating mean and variance of each set of the data of the inclination by the main processor, wherein each set of the data of the inclination comprises a plurality of units of data of the inclination; if the mean is larger than a preset angle of drinking water and the variance is less than 1°, the corresponding mean is an initial angle of drinking water; the preset angle of drinking water is 9°-15°; a maximum value of the means is determined, and the corresponding mean around the maximum value is taken as a maximum angle of drinking water;

a drinking amount calculation unit for calculating an initial water amount according to the initial angle of drinking water and capacity of the smart cup by the main processor, and calculating a remaining water amount according to the maximum angle of drinking water and capacity of the smart cup by the main processor, and then calculating a difference between the initial water amount and the remaining water amount to obtain a drinking amount.

The preset angle of drinking water is 10°.

Each set of data of the inclination calculated by the angle of drinking water analysis unit comprises 1024 units of data of the inclination.

The present invention can measure a drinking amount in real time and has no need to wait until the smart cup is in a static steady state, and a measuring element is not in contact with drinking water, so the measurement is safe and sanitary.

### BRIEF DESCRIPTION OF THE DRAWINGS

The present invention is further described in detail below with reference to the accompanying drawings and specific embodiments:

FIG. 1 is a structural schematic diagram of the smart cup of the present invention;

FIG. 2 is a schematic diagram of an electrical connection structure of the smart cup of the present invention;

FIG. 3 is a flow chart of a drinking amount detecting method for smart cup of the present invention;

FIG. 4 is a schematic diagram showing changes in inclination when drinking water;

FIG. 5 is a structural schematic diagram of a drinking amount detecting system for the smart cup of the present invention.

### DETAILED DESCRIPTION OF THE INVENTION

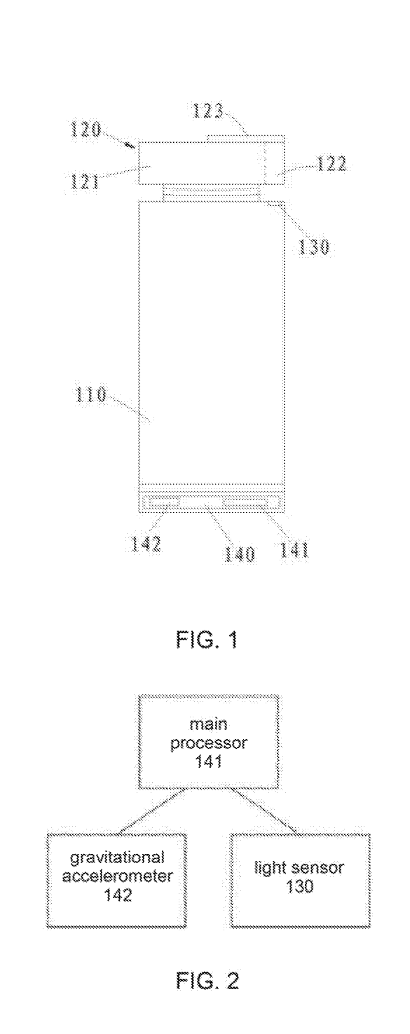

As shown in FIG. 1, a smart cup comprises a cup body 110, a cup cover 120, a light sensor 130 and a main board 140.

The cup cover 120 is arranged on the cup body 110 and can be opened or closed.

The light sensor 130 is arranged on the cup body 110 and is covered by the cup cover 120. The light sensor 130 can be exposed by opening the cup cover 120.

Specifically, the cup body 110 is screwed to the cup cover 120, and the light sensor 130 is arranged on a receiving surface where the cup body 110 is connected to a lower end surface of the cup cover 120.

Preferably, the cup cover 120 comprises a cup cover body 121, a shading tube 122 and a slide cover 123, wherein a peripheral wall of the cup cover body 121 is provided with a vertical groove, and an upper end surface of the cup cover body 121 is provided with a slide rail from the groove to a center of the cup cover body. The shading tube 122 is arranged in the groove, and the shading tube 122 is located just above the light sensor 130 after the cup cover and the cup body are screwed together. The slide cover 123 is arranged in the slide rail. The shading tube 122 has an upper tube opening which can be opened or closed by sliding the slide cover back and forth in the slide rail.

As shown in FIG. 2, the main board 140 is arranged at a bottom part of the cup body 110 and is isolated from an inner cavity of the cup body 110. The main board 140 is provided with a main processor 141 and a gravitational accelerometer 142, and the light sensor 130 and the gravitational accelerometer 142 are both connected to the main processor 141. The gravitational accelerometer 142 and the main processor 141 as a measuring element is not in contact with drinking water, which is safe and sanitary.

The light sensor 130 is used for detecting light. Whether the user has opened the cup cover 120 or the slide cover 123 and whether the user is trying to drink water are determined from the changes in light.

The gravitational accelerometer 142 is used for calculating the inclination of the smart cup relative to a vertical direction. Certainly, other sensors can also be used for calculating the inclination.

The main processor 141 is used for analyzing the initial angle of drinking water and the maximum angle of drinking water according to data of the inclination, and calculating the initial water amount and the remaining water amount according to the initial angle of drinking water and the maximum angle of drinking water; the difference between the two is the drinking amount of drinking water this time.

The present invention can measure a drinking amount in real time and has no need to wait until the smart cup is in a static steady state, and a measuring element is not in contact with drinking water, so the measurement is safe and sanitary.

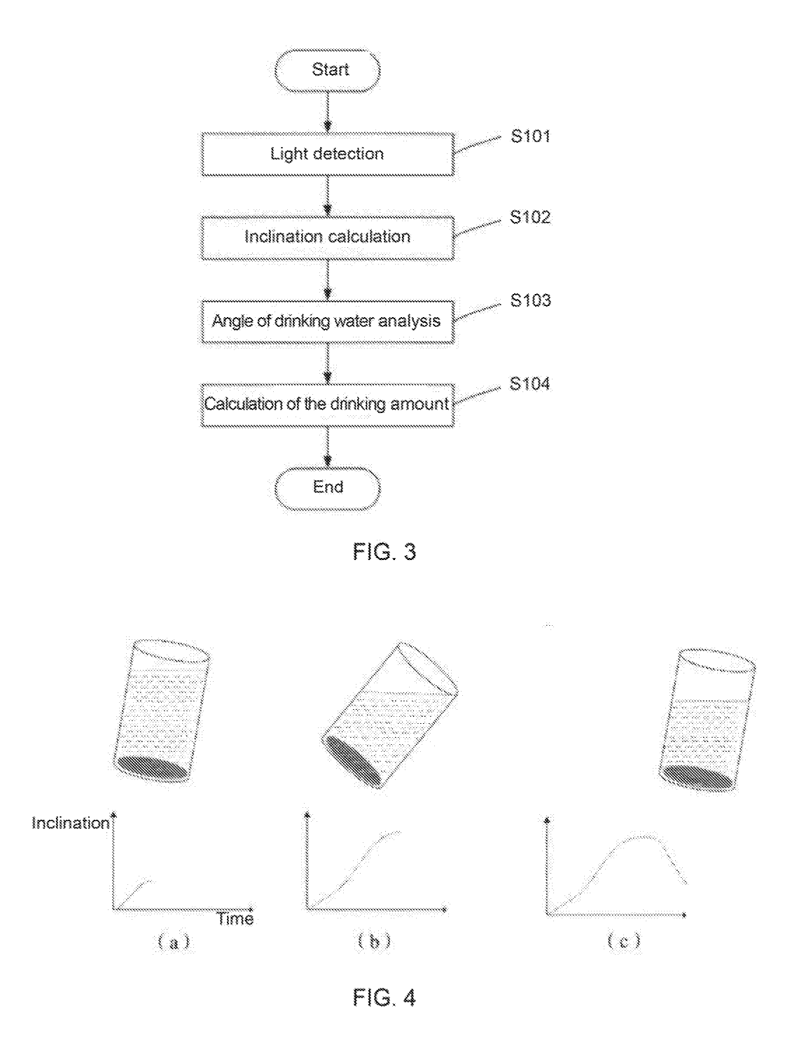

As shown in FIG. 3, a drinking amount detecting method for the smart cup of the present invention comprises:

S101, Light detection: Light is detected in real time by the light sensor 130. Detection of presence of light indicates that currently the cup cover 120 is opened or the slide cover 123 on the cup cover 120 is opened. Detection of presence of light continues after the cup cover 120 or the slide cover 123 is opened. Detection of dimming of light indicates that the user tries to drink water at this moment and the gravitational accelerometer 142 is activated.

S102, Inclination calculation: The gravitational accelerometer 142 calculates the inclination of the smart cup relative to the vertical direction, and sends data of the inclination to the main processor 141.

S103, Angle of drinking water analysis: The main processor 141 calculates mean and variance of each set of data of the inclination which comprises 10 units of data of the inclination. If the mean is larger than the preset angle of drinking water and the variance is less than 1°, the corresponding mean is the initial angle of drinking water. The preset angle of drinking water can be set to 9°-15° according to the physical characteristics of the cup body. When the angle is larger than the preset angle, begin recording the data of the inclination; the maximum of the means is determined, and the corresponding mean is taken as the maximum angle of drinking water.

Preferably, the preset angle of drinking water is 10°.

S104, Calculation of the drinking amount the main processor 141 calculates the initial water amount according to the initial angle of drinking water and the capacity of the smart cup. The main processor 141 calculates the remaining water amount according to the maximum angle of drinking water and the capacity of the smart cup. The difference between the initial water amount and the remaining water amount is calculated to obtain the drinking amount.

As shown in FIG. 4, the inclination of the cup gradually increases with time in the whole process of drinking water, and gradually decreases after reaching the maximum angle.

According to the internal physical properties of the cup, the inclination of the cup when drinking water and the remaining water amount in the cup have a corresponding relationship. The current water amount can be calculated according to the capacity and inclination of the cup. For example, an inclination of 20 degrees corresponds to a remaining water amount of 500 ml, 30 degrees corresponds to 200 ml, and 90 degrees corresponds to 0 ml.

As shown in FIG. 4(a), the angle of the cup at this time is the preset angle of drinking water. Any angle lower than this angle is considered as indicating accidental shaking but not drinking action.

As shown in FIG. 4(b), the angle of the cup at this time indicates the start of water drinking. Regardless of the water amount remaining in the cup, this initial angle of drinking water can be obtained by the position determined by the gravitational accelerometer 142, thereby determining the current amount in the cup. For example, if the initial angle of drinking water is 50 degrees, then the remaining water amount is 160 ml.

As shown in FIG. 4(c), the angle of the cup at this time indicates the end and completion of water drinking this time, and at this time the maximum inclination reached in the process of drinking water is sought. For example, 80 degrees implies that the remaining water amount is 30 ml.

Thus, the drinking amount this time is 160 ml-30 ml=130 ml.

The method of the present invention can measure a drinking amount in real time and has no need to wait until the smart cup is in a static steady state, and is safe and sanitary.

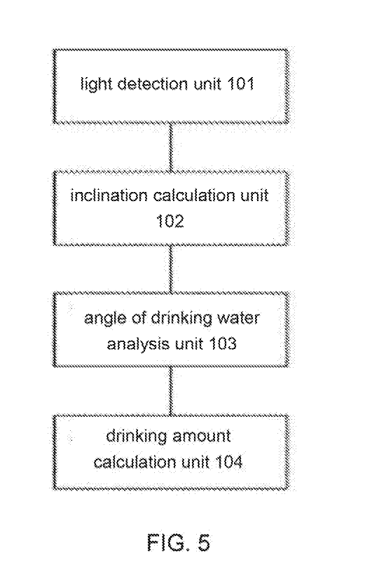

As shown in FIG. 5, the present invention also relates to a drinking amount detecting system for smart cup, comprising:

A light detection unit 101 for detecting light in real time by a light sensor 130. Detection of light indicates that the cup cover 120 is opened or the slide cover 123 on the cup cover 120 is opened. Detection of presence of light is continued after the cup cover 120 or the slide cover 123 is opened. Detection of dimming of light indicates that the user tries to drink water at this moment and the gravitational accelerometer 142 is activated.

An inclination calculation unit 102 for calculating the inclination of the smart cup relative to the vertical direction by the gravitational accelerometer 142, and sending data of the inclination to the main processor 141. Certainly, other sensors can also be used for calculating the inclination.

An angle of drinking water analysis unit 103 for calculating mean and variance of each set of data of the inclination by the main processor 141, with each set of data of the inclination comprising 10 units of data of the inclination. If the mean is larger than the preset angle of drinking water and the variance is less than 1°, the corresponding mean is the initial angle of drinking water. The preset angle of drinking water is 9°-15°; the maximum of the means is determined, and the corresponding mean is taken as the maximum angle of drinking water.

Preferably, the preset angle of drinking water is 10°.

A drinking amount calculation unit 104 for calculating the initial water amount according to the initial angle of drinking water and the capacity of the smart cup by the main processor 141, and calculating the remaining water amount according to the maximum angle of drinking water and the capacity of the smart cup by the main processor 141, and then calculating the difference between the initial water amount and the remaining water amount to obtain the drinking amount.

As shown in FIG. 4, the inclination of the cup gradually increases with time in the whole process of drinking water, and gradually decreases after reaching the maximum angle.

According to the internal physical properties of the cup, the inclination of the cup and the remaining water amount in the cup have a corresponding relationship when drinking water. The current water amount can be calculated according to the capacity and inclination of the cup. For example, an inclination of 20 degrees corresponds to a remaining water amount of 500 ml, 30 degrees corresponds to 200 ml, and 90 degrees corresponds to 0 ml.

As shown in FIG. 4(a), the angle of the cup at this time is the preset angle of drinking water. Any angle lower than this angle is considered as indicating accidental shaking but not drinking action.

As shown in FIG. 4(b), the angle of the cup at this time indicates the start of water drinking. Regardless of the water amount remaining in the cup, this initial angle of drinking water can be obtained by the position determined by the gravitational accelerometer 142, thereby determining the current amount in the cup. For example, if the initial angle of drinking water is 50 degrees, then the remaining water amount is 160 ml.

As shown in FIG. 4(c), the angle of the cup at this time indicates the end and completion of water drinking this time, and at this time the maximum inclination reached in the process of drinking water is sought. For example, 80 degrees implies that the remaining water amount is 30 ml.

Thus, the drinking amount this time is 160 ml-30 ml=130 ml.

The method of the present invention can measure a drinking amount in real time and has no need to wait until the smart cup is in a static steady state, and is safe and sanitary.

However, it should be understood by those of ordinary skill in the art that the foregoing embodiments are intended to be illustrative of the invention, and they do not imply any limitations on the invention described and claimed herein. All modifications and variations made to the foregoing embodiments within the spirit or scope of the invention are included within the scope of the invention as defined by the following claims.

1: A smart cup, characterized in that it comprises a cup body, a cup cover, a light sensor and a main board, wherein the cup cover is arranged on the cup body, the light sensor is arranged on the cup body and is covered by the cup cover, the light sensor can be exposed by opening the cup cover, the main board is arranged at a bottom part of the cup body and is isolated from an inner cavity of the cup body, the main board is provided with a main processor and a gravitational accelerometer, and the light sensor and the gravitational accelerometer are both connected to the main processor.

2: The smart cup as in claim 1, characterized in that the cup body is screwed to the cup cover, and the light sensor is arranged on a receiving surface where the cup body is connected to a lower end surface of the cup cover.

3: The smart cup as in claim 2, characterized in that the cup cover comprises a cup cover body, a shading tube and a slide cover, wherein the cup cover body has a peripheral wall with a vertical groove, and an upper end surface provided with a slide rail from the groove to a center of the cup cover body, the shading tube is arranged in the groove, and the shading tube is located just above the light sensor after the cup cover and the cup body are screwed together, the slide cover is arranged in the slide rail, the shading tube has an upper tube opening which can be opened or closed by sliding the slide cover back and forth in the slide rail.

4: A drinking amount detecting method for the smart cup as in claim 3, characterized in that it comprises:
Detecting light in real time by the light sensor; detection of presence of light indicates that the cup cover is opened or the slide cover on the cup cover is opened; after the cup cover or the slide cover is opened, detection of dimming of light indicates that user tries to drink water and the gravitational accelerometer is activated;
Calculating inclination of the smart cup relative to a vertical direction by the gravitational accelerometer, and sending data of the inclination to the main processor;
Calculating mean and variance of each set of the data of the inclination by the main processor, wherein each set of the data of the inclination comprises a pluraity of units of data of the inclination; if the mean is larger than a preset angle of drinking water and the variance is less than 1°, the corresponding mean is an initial angle of drinking water, the preset angle of drinking water is 9° to 15°; a maximum value of the means is determined, and the corresponding mean around the maximum value is taken as a maximum angle of drinking water;
Calculating an initial water amount according to the initial angle of drinking water and capacity of the smart cup by the main processor, and calculating a remaining water amount according to the maximum angle of drinking water and capacity of the smart cup by the main processor;
then calculating a difference between the initial water amount and the remaining water amount to obtain a drinking amount.

5: The drinking amount detecting method for smart cup as in claim 4, characterized in that the preset angle of drinking water is 10°.

6: The drinking amount detecting method for smart cup as in claim 4 or 5, characterized in that each set of data of the inclination comprises 1024 units of data of the inclination.

7: A drinking amount detecting system for smart cup, characterized in that it comprises:
a light detection unit for detecting light in real time by a light sensor; detection of presence of light indicates that a cup cover is opened or a slide cover on the cup cover is opened; after the cup cover or the slide cover is opened, detection of dimming of light indicates that user tries to drink water and a gravitational accelerometer is activated;
an inclination calculation unit which calculates inclination of the smart cup relative to a vertical direction by the gravitational accelerometer, and sending data of the inclination to a main processor;
an angle of drinking water analysis unit for calculating mean and variance of each set of the data of the inclination by a main processor, wherein each set of the data of the inclination comprises a plurality of units of data of the inclination, if the mean is larger than a preset angle of drinking water and the variance is less than 1°, the corresponding mean is an initial angle of drinking water, the preset angle of drinking water is 9°-15°; a maximum value of the means is determined, and the corresponding mean around the maximum value is taken as a maximum angle of drinking water;
a drinking amount calculation unit for calculating an initial water amount according to the initial angle of drinking water and capacity of the smart cup by the main processor, and calculating a remaining water amount according to the maximum angle of drinking water and capacity of the smart cup by the main processor, and the calculating a difference between the initial water amount and the remaining water amount to obtain a drinking amount.

8: The drinking amount detecting system for smart cup as in claim 7, characterized in that the preset angle of drinking water is 10°.

9: The drinking amount detecting system for smart cup as in claim 7 or 8, characterized in that each set of data of the inclination calculated by the angle of drinking water analysis unit comprises 1024 units of data of the inclination.
